(19) United States
(12) Patent Application Publication
(10) Pub. No.: US 2026/0079230 A1
(43) Pub. Date: Mar. 19, 2026

(54) Remote Location Tracking

(71) Applicant: DISH Network Technologies India Private Limited, Englewood, CO (US)

(72) Inventors: Srinidhi A N, Shivamogga (IN); Srinivasarao Duddu, Bengaluru (IN); Manasa Jami, Madhurawada (IN); Praveen Kumar G, Mangalore (IN); Sreevastav Anupuru, Kurnool (IN)

(73) Assignee: DISH Network Technologies India Private Limited, Englewood, CO (US)

(21) Appl. No.: 18/885,679

(22) Filed: Sep. 15, 2024

(51) Int. Cl. G01S 5/14; G01S 5/02; H04N 21/422; H04N 21/426; H04N 21/431

(52) U.S. Cl. CPC G01S 5/14; G01S 5/02213; H04N 21/42221; H04N 21/426; H04N 21/4312

(57) ABSTRACT

Devices, systems and methods are described for tracking and identifying to a user a current location of a remote control. A system may include a remote control having an ultra-wideband (UWB) tag generating a remote ranging signal (RRS) and a set top box (STB) having a processor, a UWB anchor and a non-transitory STB data store (STBDS) storing first computer instructions (1CIs) that instantiate a first remote tracking and location determination engine. The UWB anchor has a first UWB receiving element (1UWBRE) and a second UWB receiving element (2UWBRE). The instructions configure the STB to perform remote tracking operation that include receiving the RRS by each of the 1UWBRE and the 2UWBRE, and determining, based thereon, a current distance of the remote from the STB at a given current time. The 1UWBRE has a first field-of-view (1FOV). The 2UWBRE has a second FOV.

### TECHNICAL FIELD

The technology described herein generally relates to devices, systems, and methods for tracking a remote control device within an environ and for identifying, to a user, a current location of the remote control device.

### BACKGROUND

Homes, apartments, offices, and other places (herein, such areas being commonly referred to as a “environ”) commonly include multiple areas, with non-limiting examples including one or more bedrooms, bathrooms, kitchen, hallways, storage rooms/closets, garages, common areas, offices, yards, surroundings, or the like. Environs also commonly include various electronic devices and systems. Non-limiting examples of such electronic devices include televisions, cable and satellite set top boxes, streaming devices, such as ROKU streaming sticks, security control systems, automated blinds, fireplaces, and the like (herein, individually and collectively, an “electronic device” or “device”—as further defined herein). Such devices often include and/or are controllable using a remote control device (herein, a “remote”). As is commonly known, a remote is typically portable, in that a human user may pick up the remote and utilize the remote to control one or more functions, features, settings, and the like of one or more devices from one or more areas, within an environ, that are within radio frequency or other signaling range of the remote.

Being portable, users of the remote may pick up and move the remote from place to place—leaving the remote, at any given time, in any location within the environ. Often a given remote may have one or more, and often multiple, users thereof. The singular and/or multiple users of a given remote may forget, or not know, where the remote was last left (placed) within the environ. Accordingly, a given user may not know, at a given time, where the remote is located.

Commonly, various devices may include remote locator technologies that are configured to, hopefully, assist a user with locating a given remote. A non-limiting example of such a technology is the DISH NETWORK remote locator technology, which includes a button on a set-top box (STB) that, when pushed, instructs the remote(s) within range of the STB to emit a sound and flash one or more light emitting diodes (LEDs) on the remote. While this technology works adequately when the given remote is in the same room of the user, is readily visible (e.g., not being hidden by a pillow, cushion or other item), and/or is within hearing range and frequencies of the given user, such approach is lacking in many other circumstances—such as when the remote is in another room, the user is hearing impaired, the remote is buried under pillows or cushions, or otherwise.

Accordingly, devices, systems and methods are needed for tracking a remote as it is moved throughout an environ and providing audible and visible indicators to a given user of where the remote may be found, within the environ, at a given time.

### SUMMARY

Various implementations are described of devices, systems, and methods for tracking a remote within an environ and providing audible and/or visible indicators to a user of a last known location of the remote within the environ. The last known location may correspond to a current location of the remote.

In accordance with at least one implementation of the present disclosure, a system of one or more computers, devices, and the like can be configured to perform particular operations or actions by virtue of having software, firmware, hardware, or a combination thereof installed on the system that, in operation, cause(s) the system to perform the actions. One or more computer programs can be configured to perform particular operations or actions by virtue of including instructions that, when executed by a data processing apparatus, cause the apparatus to perform the actions.

For at least one implementation, a system may include a remote control device that includes an ultra-wideband (UWB) tag (UWBT) generating a remote ranging signal (RRS) and a set top box (STB), coupled to the remote control. The STB may include an STB processor (STBP) and an STB UWB anchor (STB-UWBA), coupled to the STBP. The STB-UWBA may include a first UWB receiving element (1UWBRE) and a second UWB receiving element (2UWBRE). The STB may further include a non-transitory STB data store (STBDS), coupled to the STBP, non-transitorily storing first computer instructions (1CIs). The 1CIs, when executed by the STBP, may instantiate a first remote tracking and location determination engine (1RTLDE) which configures the STB to perform remote tracking operation (RTOs). The RTOs may include first receiving the RRS by the 1UWBRE, second receiving the RRS by the 2UWBRE, and determining, based on the first receiving and the second receiving, a current distance of the remote from the STB at a given current time.

For at least one implementation of the system the 1UWBRE may have a first field-of-view (1FOV), the 2WUBRE may have a second field-of-view (2FOV), and the current distance is further determined based on differences between the 1FOV and the 2FOV. For at least one implementation, the 1FOV may overlap with the 2FOV and for another implementation, the 1FOV may not overlap with the 2FOV.

For at least one implementation, the STB-UWBA may further include a third UWB receiving element (3UWBRE) having a third field-of-view (3FOV) and the RTOs may include third receiving the RRS by the 3UWBRE, and second determining, based on the 1FOV, the 2FOV and the 3FOV, a current orientation, in a two-dimensional space, of the remote relative to the STB. For at least one implementation, the STB may be positioned at a fixed location in an environ and the current distance with the current orientation identify a current location of the remote relative to the fixed location of the STB in the environ.

For at least one implementation, the STB-UWBA may include a fourth UWB receiving element (4UWBRE) having a fourth field-of-view (4FOV) and the RTOs may further include: fourth receiving the RRS by the 4UWBRE, and third determining, based on the 1FOV, the 2FOV, the 3FOV and the 4FOV, a current orientation, in a three-dimensional space, of the remote relative to the STB.

For at least one implementation, the RTOs may further include determining, at least one of: for the first receiving, a first received signal strength (1RSS) of the RRS; for the second receiving, a second received signal strength (2RSS) of the RRS; for the third receiving, a third received signal strength (3RSS) of the RRS; and for the fourth receiving, a fourth received signal strength (4RSS) of the RRS; and wherein the current distance is further determined based on at least one of the 1RSS, the 2RSS, the 3RSS and the 4RSS.

For at least one implementation, the RRS may be transmitted by the UWBT at a given transmission time; the RRS identifies the given transmission time; the RRS is received by at least one of the 1UWBRE, the 2UWBRE, the 3UWBRE, and the 4UWBRE; the 1UWBRE receives the RRS at a first reception time; the 2UWBRE receives the RRS at a second reception time; the 3UWBRE receives the RRS at a third reception time; the 4UWBRE receives the RRS at a fourth reception time; the first reception time, the second reception time, the third reception time and the fourth reception time occur after the given transmission time; and the distance of the remote from the STB is determined based on differences between the transmission time and one or more of the first reception time, the second reception time, the third reception time and the fourth reception time.

For at least one implementation, the first reception time differs from the second reception time; at least one of the first reception time and the second reception time differ from the third reception time; and at least two of the first reception time, the second reception time and the third reception time differ from the fourth reception time.

For at least one implementation, the system may further include a user device (UD) coupled to the STB; and the RTOs may further include: determining, at the given current time: a second distance of the UD from the STB and a second orientation of the UD relative to the STB; adjusting the current distance of the remote to the STB based on the second distance to generate a revised distance indicative of a distance of the remote to the UD at the given current time; adjusting the current orientation of the remote to the STB based on the second orientation to generate a revised orientation indicative of an orientation of the remote to the UD at the given current time; and outputting, to the UD, second remote location data (2RLD) indicative of the revised distance and the revised orientation.

For at least one implementation, the UD may include: a user device user interface (UDUI); a user device communications interface (UDCI); a non-transitory UD data store (UDDS), non-transitorily storing second computer instructions (2CIs); and a UD processor (UDP), coupled to the UDUI, the UDCI, and the UDDS. For at least one implementation, the 2CIs, when executed by the UDP, may instantiate a second remote tracking and location determination engine (2RTLDE) which configures the UD to perform second remote location operations (2RLOs) comprising: receiving the 2RLD from the STB. The 2RLD may include second remote distance data (2RDD), second remote orientation data (2ROD), and second graphical icon data (2GID) and the 2RLOS may further include converting the 2RLD into second remote distance information (2RDI), second remote orientation information (2ROI), and at least one second graphical icon (2GI), and presenting, via the UDUI, the 2RDI and the 2ROI to the user.

For at least one implementation, the UDUI may present the at least one 2GI as an arrow indicative of the revised distance and the revised orientation.

For at least one implementation, the system may further include a television (TV) coupled to the STB and the 1RTLDE may perform remote location operations (RLOs) comprising: determining whether the STB and the TV are adjacent; when not adjacent, determining a relative distance of the STB to the TV; and adjusting the current distance of the remote from the STB by the relative distance to generate an adjusted distance indicative of a distance of the remote to the TV.

For at least one implementation, the 1RTLDE may further perform remote location operations (RLOs) including: when the STB and TV are not adjacent, determining a relative orientation of the STB to the TV; and adjusting the current orientation of the remote to the STB by the relative orientation to generate an adjusted orientation indicative of an orientation of the remote to the TV.

For at least one implementation, the 1RTLDE may further configure the STB to perform remote location operations (RLOs) including: generating first remote distance data (1RDD) indicative of at least one of the current distance and the adjusted distance; generating first remote orientation data (1ROD) indicative of at least one of the current orientation and the adjusted orientation; and outputting the 1RDD and the 1ROD to the TV for presentation to a user.

For at least one implementation, the RLOs may further include generating first graphical icon data (1GID) based on the 1RDD and 1ROD.

For at least one implementation, the TV may convert the 1RDD into first remote distance information (1RDI); the TV may convert the 1ROD into first remote orientation information (1ROI); the TV may convert the 1GID into a first graphical icon (1GI); and the TV may present the 1RDI, the 1ROI and the 1GI, in a humanly perceptible format, to at least one user.

For at least one implementation, the STB may be located at fixed location with an environ at the given current time; the remote may be located at a second location within the environ that is at the current distance from the STB; and the 1RTLDE may configure the STB to perform mapping operations including obtaining a floor plan of the environ. The floor plan may identify a given confine within the environ. The mapping operations may further include identifying, within the given confine, a first confine area at which the STB is located at the given current time, determining, based on the current distance whether the remote is within the first confine area, and when the remote is determined to be within the first confine area, generating first remote location data indicative thereof. When the remote is determined to not be within the first confine area, the mapping operations may include identifying at least one second given confine, within the environ, that is within the current distance of the remote and generating second remote location data indicative thereof.

For at least one implementation, the mapping operations may further include further identifying an article in the first confine area and the first remote location data may further identify the current location of the remote relative to the article.

### BRIEF DESCRIPTION OF THE DRAWINGS

The features, aspects, advantages, functions, modules, and components of the devices, systems, and methods provided by the various implementations of the present disclosure are further disclosed herein regarding at least one of the following descriptions and accompanying drawing figures. In the appended figures, similar components or elements of the same type may have the same reference number and may include an additional alphabetic designator, such as 108a-108n, and the like, wherein the alphabetic designator indicates that the components bearing the same reference number, e.g., 108, share common properties and/or characteristics. Further, various views of a component may be distinguished by a first reference label followed by a dash and a second reference label, wherein the second reference label is used for purposes of this description to designate a view of the component. When the first reference label is used in the specification, the description is applicable to any of the similar components and/or views having the same first reference label irrespective of any additional alphabetic designators or second reference labels, if any.

FIG. 1 is a schematic illustration of an illustrative and non-limiting environ in which an implementation of a remote tracking and location identification system (RTLIS) may be utilized and in accordance with at least one implementation of the present disclosure.

FIG. 2 is a schematic illustration of a remote positioned at various locations within the environ illustrated in FIG. 1 and in accordance with at least one implementation of the present disclosure.

FIG. 3 is a schematic illustration of an RTLIS and in accordance with at least one implementation of the present disclosure.

FIGS. 4A and 4B are a top view and a size view of the fields-of-view for multiple UWB anchor-antenna-receiving elements utilized in accordance with the RTLIS of FIG. 3 and in accordance with at least one implementation of the present disclosure.

FIG. 5 is a schematic illustration of a television display providing remote location information to a user of the RTLIS of FIG. 3 and in accordance with at least one implementation of the present disclosure.

FIG. 6 is a schematic illustration of a second RTLIS and in accordance with at least one implementation of the present disclosure.

FIG. 7 is a schematic illustration of a user device display providing remote location information to a user of the RTLIS of FIG. 6 and in accordance with at least one implementation of the present disclosure.

FIG. 8 is a flow chart illustrating operations for remote tracking and location identification and in accordance with at least one implementation of the present disclosure.

### DETAILED DESCRIPTION

Various implementations of the present disclosure describe devices, systems, and methods for tracking a remote control device within an environ and for identifying, to a user, a current location of the remote control device.

“Additional I/O interface” (AIOI) herein refers to one or more components, provided with or coupled to a device, configured to support a receiving and/or presenting of additional inputs and outputs to and from one or more users. An AIOI may be configured to support the receiving and presenting of the additional I/O content (AIO) to users. Herein, the AIO, as communicated, may be referred to as “AIO signals.” An AIO signal may include an audible signal or a visible signal and may be communicated separately or collectively therewith. An AIOI may include any interface not otherwise categorized as an Audio I/O interface or a Visual I/O interface with non-limiting examples including touch pads, keyboards, sensors, motion detectors, tactile elements, and the like. Any known or later arising technologies configured to convey information to or from one or more users as an AIO signal may be utilized for at least one implementation of the present disclosure. An AIOI includes hardware and computer instructions (herein, “AIO technologies”) which supports the input and output of other signals with a user.

“Application” herein refers to a set of computer instructions that configure one or more processors to perform one or more tasks that are other than tasks commonly associated with the operation of the processor itself (e.g., a “system software,” an example being an operating system software), or the providing of one or more utilities provided by a device (e.g., a “utility software,” an example being a print utility). An application may be bundled with a given device or published separately. Non-limiting examples of applications include word processing applications (e.g., Microsoft WORD™), video streaming applications (e.g., SLINGTV™), video conferencing applications (e.g., ZOOM™), gaming applications (e.g., FORTNITE™), and the like.

“Audio I/O interface” herein refers to one or more components, provided with or coupled to an electronic device, configured to support a receiving and/or presenting of humanly perceptible audible content to one or more users. Such audible content (which is also referred to herein as being “audible signals”) may include spoken text, sounds, or any other audible information. Such audible signals may include one or more humanly perceptible audio signals, where humanly perceptible audio signals typically arise between 20 Hz and 20 KHz. The range of humanly perceptible audio signals may be configurable to support an audible range of a given individual user. An audio I/O interface includes hardware and computer instructions (herein, “audio technologies”) which supports the input and output of audible signals to a user. Such audio technologies may include, but are not limited to, noise cancelling, noise reduction, technologies for converting human speech to text, text to speech, translation from a first language to one or more second languages, playback rate adjustment, playback frequency adjustment, volume adjustments and otherwise. An audio I/O interface may use one or more microphones and speakers to capture and present audible signals respectively from and to a user. Such one or more microphones and speakers may be provided by a given device itself or by a device communicatively couple additional audible device component. For example, earbuds may be communicatively coupled to a smartphone, with the earbuds functioning as an audio I/O interface and capturing and presenting audio signals as sound waves to and from a user, while the smartphone functions as a UD. An audio I/O interface may be configured to automatically recognize, and capture comments spoken by a user and intended as audible signals for sharing with other users, inputting commands, or otherwise.

“Bus” herein refers to any known and/or later arising technologies which facilitate the transfer of data within and/or between components of a device. Non-limiting examples include Universal Serial Bus (USB), PCI-Express, Compute Express Link (CXL), IEEE-488 bus, High Performance Parallel Interface (HIPPI), and the like.

“Cloud” herein refers to cloud computing, cloud storage, cloud communications, and/or other technology resources which a given user does not actively manage or provide. A usage of a Cloud resource may be private (limited to various users and/or uses), public (available for multiple users and/or uses), hybrid, dedicated, non-dedicated, or otherwise. It is to be appreciated that implementations of the present disclosure may use Cloud resources to provide for processing, storage and other functions related to facilitating the features and functions described herein. An implementation may utilize Cloud resources using any known or later arising data delivery, processing, storage, virtualization, or otherwise technologies, standards, protocols (e.g., the Simple Object Access Protocol (SOAP), the Hyper Text Transfer Protocol (HTTP), Representational State Transfer protocol (REST), or the like. Non-limiting examples of such technologies include Software as a Service (Saas), Platform as a Service (Paas), Infrastructure as a Service (Iaas), and the like. Cloud resources may be provided by one or more entities, such as AMAZON WEB SERVICES provided by Amazon.com Inc., AZURE provided by Microsoft Corp., and others.

“Communications Interface” herein refers to one or more separately provided components and/or integrated with other components of a Device that is configured to facilitate communication of data with one or more other devices using a Coupling. Non-limiting examples of communications interfaces including networking cards, Wi-Fi™ modules, Ethernet ports, Bluetooth radio modules, wireless radio modules, and the like. Any known or later arising components, technologies, protocols, communications mediums, or the like may be used as a communications interface in a given device in a sports results implications system.

“Component” herein refers to a Module of a Device, as further defined herein.

“Computer Data” herein refers to Data, as further defined herein.

“Computer engine” (or “engine”) herein refers to a combination of a processor and computer instruction(s). A computer engine executes computer instructions to perform one or more logical operations (herein, a “logic”) which facilitate various actual (non-logical) and tangible features and function provided by a system, a device, and/or combinations thereof.

“Computer instruction” herein refers to an Instruction, as further defined herein.

“Content” herein refers to data that that may be presented, using a suitable presentation device, to a user in a humanly perceptible format. When presented to a human, the data becomes “information.” Non-limiting examples of content include images and graphics such as those related to television programs, streaming video, music, or otherwise. Content may include, for example and not by limitation, one or more sounds, images, video, graphics, gestures, or otherwise. The content may originate from any source, including live and/or recorded, augmented reality, virtual reality, computer generated, or otherwise. The content may be presented to a given user using any user device and any user interface. Content may be stored, processed, communicated, or otherwise utilized. Content may identify artists, events, venues or the like.

“Coupling” herein refers to the establishment of a communications link between two or more elements of a given device and/or system. A coupling may utilize any known and/or later arising communications and/or networking technologies, standards, protocols or otherwise. Non-limiting examples of such technologies include packet switch and circuit switched communications technologies, with non-limiting examples including, Wide Area Networks (WAN), such as the Internet, Local Area Networks (LAN), Public Switched Telephone Networks (PSTN), Plain Old Telephone Service (POTS), cellular communications networks such as a 3G/4G/5G or other cellular network, IoT networks, Cloud based networks, private networks, public networks, or otherwise. One or more communications and networking standards and/or protocols may be used, with non-limiting examples including, the TCP/IP suite of protocols, ATM (Asynchronous Transfer Mode), the Extensible Message and Presence Protocol (XMPP), Voice Over IP (VOIP), Ethernet, Wi-Fi, CDMA, Z-WAVE, Near Field Communications (NFC), GSM/GRPS, TDMA/EDGE, EV/DO, WiMAX, SDR, LTE, MPEG, BLUETOOTH, and others. A coupling may include use of physical data processing and communication components. A coupling may be physically and/or virtually instantiated. Non-limiting examples of physical network components include data processing and communications components including computer servers, blade servers, switches, routers, encryption components, decryption components, and other data security components, data storage and warehousing components, and otherwise. Any known or later arising physical and/or virtual data processing and/or communications components may be utilized for a given coupling.

“Data” herein refers to any representation of facts, information or concepts in a form suitable for processing, storage, communication, or the like by one or more electronic device processors, data stores, routers, gateways, or other data processing and/or communications devices and systems. Data, while and/or upon being processed, may cause or result in an electronic device or other device to perform or not perform at least one function, task, operation, provide a result, or otherwise. Data may be communicated, processed, stored and/or otherwise exist in a transient and/or non-transient form, as determined by any given state of such data, at any given time. For a non-limiting example, a given data packet may be non-transient while stored in a storage device, but transient during communication of the given data packet from a first device or system to a second (or more) device or system. When received and stored in one or more of a cache, a memory, a data storage device, or otherwise, the given data packet has a non-transient state. For example, and not by limitation, data may take any form including as one or more applications, content, or otherwise. Instructions, as further described herein, are a form of data.

“Data store” herein refers to any non-transitory device, combinations of devices, component of a device, combinations of components of one or more devices, or the like configured to store data on a temporary, permanent, non-transitory, or other basis. A data store is also referred to herein as a “computer readable medium” and/or a “non-transitory computer readable medium.” A data store may store data in any form, such as electrically, magnetically, physically, optically, or otherwise. A data store may include a cache on a processor, memory devices, with non-limiting examples including random access memory (RAM) and read only memory (ROM) devices, and the like. A data store may include one more storage devices, with non-limiting examples including electrical storage drives such as EEPROMs, Flash drives, Compact Flash (CF), Secure Digital (SD) cards, Universal Serial Bus (USB) cards, and solid-state drives, optical storage drives such as DVDs and CDs, magnetic storage drives such as hard drive discs, magnetic drives, magnetic tapes, memory cards, and others. Any known or later arising data storage device technologies may be utilized for a given data store. Available storage provided by a given one or more data stores may be partitioned or otherwise designated by a storage controller as providing for permanent storage and temporary storage. Non-transitory data, computer instructions, or other the like may be suitably stored in a data store permanently or temporarily. As used herein, permanent storage is distinguished from temporary storage, with the latter providing a location for temporarily storing data, variables, or other instructions used for a then arising or soon to arise data processing operations. A non-limiting example of a temporary storage is a memory component provided with and/or embedded onto a processor or integrated circuit provided therewith for use in performing then arising data calculations and operations. Accordingly, it is to be appreciated that a reference herein to “temporary storage” is not to be interpreted as being a reference to transitory or transient storage of data. Permanent storage and/or temporary storage may be used to store data which, while communicated may be transitory, non-transitory, and transient or non-transient, but while stored, is defined herein to be a form of non-transitory and non-transient data.

“Device” and “electronic device” herein refer to any known or later arising electrical device configured to, singularly and/or in combination, communicate, manipulate, output (e.g., for presentation as information to a human), process, store, or otherwise utilize data. Non-limiting examples of devices include User Devices, Set Top Boxes, and Servers.

“Entity” refers to a human being, an animal, a robot, an artificial intelligence, or a combination or collection of two or more of the foregoing that participate in a given event.

“Information” herein refers to data that is converted into a humanly perceptible and understandable format. Information is presented to one or more users using one or more User Interfaces (as defined below).

“Instruction” herein refers to a non-transitory processor executable instruction, associated data structures, sequence of operations, program modules, or the like. An instruction is described by an instruction set. It is commonly appreciated that instruction sets are often processor specific and accordingly an instruction may be executed by a processor in a language format (e.g., a machine language format) that is translated from a higher level programming language (e.g., C++). An instruction may be provided using any form of known or later arising programming; non-limiting examples including declarative programming, imperative programming, functional programming, procedural programming, stack based programming, object-oriented programming, and otherwise. An instruction may be performed by using data and/or content stored in a data store on a transitory, transient, non-transitory, and/or non-transient basis, as may arise for any given data, content and/or instruction.

“Module” herein refers to and, when claimed, recites definite structure for a device, and/or one or more components thereof, that is configured to provide at least one feature and/or output signal and/or perform at least one function including one or more of the features, output signals and functions described herein. A module may provide the one or more functions using computer engines, processors, computer instructions, and the like. When a feature, output signal and/or function is provided, in whole or in part, using a processor, one more software components may be used, and a given processor may include a processor module configured to execute computer instructions. The specific hardware and/or computer instructions used for a given implementation will depend upon the functions to be accomplished by a given module. Likewise, the computer instructions may be provided in firmware, as embedded software, provided in a remote and/or local data store, accessed from other sources on an as-needed basis, or otherwise. Any known or later arising technologies may be used to provide a given module and the features and functions supported therein.

“Monitor” herein refers to a device, such as a server, which facilitates monitoring services. Non-limiting examples of monitors include those provided by CONTROL4™, Apple HomeKit™, Google NEST™, Philips HUE™, CRESTRON™, LOREX™, ADT™, and others. A monitor may be located within one or more actual and/or virtualized processors provided within a given environment and/or external to a given environment, such as a web server, a Cellular server, or otherwise. Devices may be coupled to a monitor using any known or later arising wireless coupling technologies.

“Node” herein refers to a device, configured for use in a mesh network, which performs one or more “networked functions.” Non-limiting examples of nodes include: “computing devices,” such as laptop computers, personal computers, tablet computing devices, desktop computers, smartphones, smartwatches, and the like; “smart devices,” such as smart thermostats, smart light bulbs, smart alarm systems, smart doorbells, smart locks, smart appliances, such as refrigerators, ovens, coffee makers; and any other device capable of wirelessly communicating with another node or router on a given mesh network. A “networked function” includes any function that a computing device, a smart device, or another networked device can perform. For a non-limiting example, a networked function of a smart device may include turning on or off of one or more lamps, raising/lowering blinds, changing temperature settings of a thermostat, or the like. A node may be configured to operate independently (e.g., raise blinds when daylight is detected) and/or based upon instructions and data received from a monitor connected thereto. A node may be connected to a monitor by a wired or wireless coupling directly, or indirectly (e.g., via a router and/or one or more other nodes connected by a router to a “monitor”).

“PHOSITA” herein refers to a person having ordinary skill in the art.

“Power Supply/Power/Power Module” herein refers to any known or later arising technologies which facilitate the providing to and/or use by a device of electrical power. Non-limiting examples of such technologies include batteries, power converters, inductive charging components, line-power components, solar power components, and otherwise.

“Processor” herein refers to one or more known and/or later developed hardware processors and/or processor systems configured to execute one or more computer instructions, with respect to one or more instances of computer data, and perform one or more logical operations. The computer instructions may include instructions for executing one or more applications, software engines, and/or processes configured to perform computer executable operations. Such hardware and computer instructions may arise in any computing configuration including, but not limited to, local, remote, distributed, blade, virtual, or other configurations and/or system configurations. Non-limiting examples of processors include discrete analog and/or digital components that are integrated on a printed circuit board, as a system on a chip (SOC), or otherwise; Application specific integrated circuits (ASICs); field programmable gate array (FPGA) devices; digital signal processors; general purpose processors such as 32-bit and 64-bit central processing units; multi-core ARM based processors; microprocessors, microcontrollers; and the like. Processors may be implemented in single or parallel or other implementation structures, including distributed, Cloud based, and otherwise.

“Security Component/Security/Security Module” herein refers to any known or later arising components, processors, computer instructions, modules, and/or combinations thereof configured to secure data as communicated, processed, stored, output for presentation to a user, or otherwise manipulated. Non-limiting examples of security components include those which implement encryption/decryption standards, such as an Advanced Encryption Standard (AET), and transport security standards, such as Transport Layer Security (TLS) or Secure Sockets Layer (SSL).

“Server” herein refers to one or more devices that include computer hardware and/or computer instructions that provide functionality to one or more other programs or devices (collectively, “clients”). Non-limiting examples of servers include content servers, database servers, file servers, application servers, web servers, communications servers, virtual servers, computing servers, and the like. Servers may be combined into clusters (e.g., a server farm), logically or geographically grouped, combined into neural networks, or otherwise configured and/or utilized. Any known or later arising technologies may be used for a server.

A server may instantiate one or more computer engines as one or more threads operating on a computing system having a multiple threaded operating system, such as the WINDOWS, LINUX, APPLE OS, ANDROID, and other operating systems, as an application program on a given device, as a web service, as a combination of the foregoing, or otherwise. An Application Program Interface (API) may be used to support an implementation of the present disclosure. A server may be provided in the virtual domain and/or in the physical domain. A server may be associated with a human user, a machine process executing on one or more computing devices, an API, a web service, instantiated on the Cloud, distributed across multiple computing devices, or otherwise. A server may be any electronic device configurable to communicate data using a network, directly or indirectly, to another device, to another server, or otherwise.

“Set Top Box” (STB) herein refers to one or more devices, servers, data stores, communications interfaces, and related components which, singularly and/or cooperatively, facilitate one or more features and functions of the present disclosure. An STB may include one or more processors, data stores, communications interfaces, user interfaces, busses, and related components. Non-limiting examples of STBs include satellite receivers, such as a HOPPER™ by DISH Network L.L.C. of Englewood, Colorado, streaming devices, such as an APPLE TV® by Apple, Inc. of Cupertino California, a streaming application and/or streaming server, such as a NETFLIX® application and/or NETFLIX server provided by Netflix Inc. of Los Gatos, California, a smart television, such as a QE1C QLED 4K® television by Samsung corporation of Samsung Digital City, South Korea, a cable receiver, such as an X1® television box by XFINITY Inc., a division of Comcast Inc. of Philadelphia, Pennsylvania, and/or any other device, component, software, application or the like configured to singularly or cooperatively facilitate one or more features and functions of the present disclosure. The STB devices, components and the like may be physically, logically, virtually, or otherwise grouped and/or coupled to facilitate the one or more features and functions including, but not limited to, those identified herein.

“Substantially simultaneous(ly)” herein refers to an absence of a greater than expected and humanly perceptible delay between a first event or condition and a second event or condition. Substantial simultaneity may vary in a range of quickest to slowest expected delay, to a moderate delay, or to a longer delay.

“User” herein refers to one or more of a single person, a household of people (such as those in a family), a collection of people (e.g., those in a fraternal organization or a club), or any other association of one or more human beings. A given household may have multiple users and/or collections of users (e.g., parents being one collection of users with children being a second collection of users in a household).

“User Device” (UD) herein refers to a device configured for use by a user to communicate, generate, compute, present, process, store, or otherwise manipulate data and/or present information to and/or receive information from a user. Non-limiting examples of user devices include smartphones, laptop computers, tablet computing devices, desktop computers, smart televisions, smart glasses, virtual reality glasses, augmented reality glasses, earbuds/headphones and other audible output devices, and other devices.

“User Interface” herein refers to one more components, provided with or coupled to a device configured to receive information from and/or present information to a user and convert information to data and vice versa. A user interface may include one more Additional I/O interfaces, Audio I/O interfaces, and Visual I/O interfaces.

“Visual I/O interface” herein refers to one or more components, provided with or coupled to a device, configured to support a receiving and/or presenting of humanly perceptible visual content to one or more users. A visual I/O interface may be configured to support the receiving and presenting of visual content (which is also referred to herein as being “visible signals”) to users. Such visible signals may be in any form, such as still images, motion images, augmented reality images, virtual reality images, and otherwise. A visual I/O interface includes hardware and computer instructions (herein, “visible technologies”) which supports the input by and output of visible signals to users via a device. Such visible technologies may include technologies for converting images (in any spectrum range) into humanly perceptible images, converting content of visible images into a given user's perceptible content, such as by character recognition, translation, playback rate adjustment, playback frequency adjustment, and otherwise. A visual I/O interface may be configured to use one or more display devices, such as an internal display and/or external display for a given device with the display(s) being configured to present visible signals to a user. A visual I/O interface may be configured to use one or more image capture devices to capture content. Non-limiting examples of image capture devices include lenses, cameras, digital image capture and processing software, and the like. Accordingly, it is to be appreciated that any existing or future arising visual I/O interfaces, devices, systems and/or components may be utilized by and/or in conjunction with a device to facilitate the capture, communication and/or presentation of visible signals to a user.

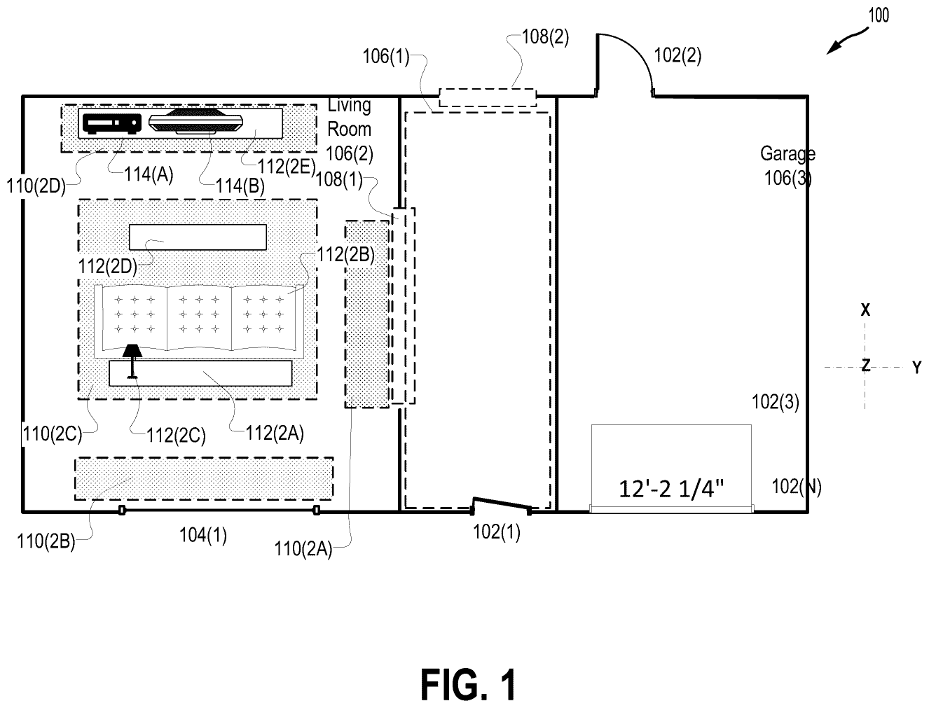

As shown in FIG. 1 and for at least one implementation of the present disclosure, an environ 100, such as a home, may include numerous confines 106 and articles 112. For a non-limiting example, an environ 100 may include a front door 102(1), a back door 102(2) and a garage door 102(3), and one or more windows, such as a front window 104(1). The environ 100 may also include one or more confines 106, such as a hall 106(1), a living room 106(2), a garage 106(3), and other areas (not shown), and one or more passageways 108, such as a first passageway 108(1) between the living room 106(2) and the hall 106(1), and a second passageway 108(2) between the hall 106(1) and other, non-shown confines in the environ.

Within a given confine 106, one or more confine areas 110 may exist and/or be logically defined. For a non-limiting example, a living room 106(2) may include a first living room confine area 110(2A) that may be logically and/or physically defined as a walking or transition area between the living room 106(2) and the hall 106(1). The living room 106(2) may include a second living room confine area 110(2B), e.g., in front of the front windows 104(1), a third living room confine area 110(2C), and a fourth living room confine area 110(2D). Herein, the indicators “110(NL)” are used to refer to a confine area 110 with the “N” indicating area “2” and the “L” indicating a subset thereof, e.g., 110(2A) identifying confine area 110(2) as being the living room, and “A” identifying a subset therein, such as the transition confine area.

Further, a given confine area may include one or more articles 112. As used herein, an “article” is any movable item within a confine area 110, confine 106, and/or environ 100. Non-limiting examples of articles 112 include furniture and other household items with non-limiting examples including lamps, rugs, pillows, cushions, blankets, or the like. As shown for purposes of illustration, the third living room confine area 110(2C) may include articles including a sofa table 112(2A), a sofa 112(2B), a lamp 112(2C), and a coffee table 112(2D). As further shown, the fourth living room confine area 110(2D) may include articles including an entertainment center 112(2E). The entertainment center 112(2E) may house one or more electronic devices including an STB 114(A) and a television 114(B). The STB 114(A) may be coupled to the television 114(B). It is to be appreciated that a given implementation of the present disclosure may include any number of confines 106, confine areas 110, article 112, and devices 114 and one or more of the devices 114 may be coupled to each other.

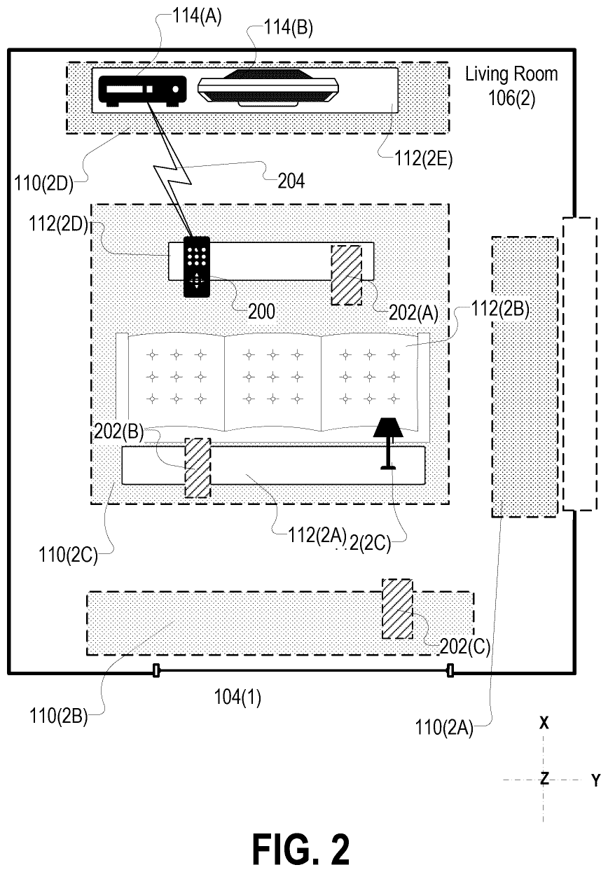

As shown in FIG. 2, wherein an enlarged representation of a living room confine 106(2) is shown, a remote 200 may be positioned within a given environ, such as the living room confine 106(2), at one or more different remote locations 202, at any given time. For example, at a first time, the remote 200 may be located at a first remote location 202(A) (as shown by the hashed rectangular box). At a second time, the remote 200 may be located at a second remote location 202(B). At a third time, the remote 200 may be located at a third remote location 202(C). Further, the remote location 202 may be located outside of a given confine, such as in the garage confine 106(3) (as shown in FIG. 1 but not shown in FIG. 2), or elsewhere.

For at least one implementation of the present disclosure, the remote 200 may be configured to include an ultra-wideband (UWB) or similar transmitter that emits a remote ranging signal (RRS) 204 to the STB 114(A). The RRS 204 may be transmitted by the remote 200 at any given time, periodicity, in response to a location signals sent by the STB 114(2A), or otherwise. For at least one implementation, the RRS 204 may be transmitted by the remote 200 whenever a keypad, touch pad, voice command, or other user input is provided to the remote 200 and such user input is further communicated by the remote 200 to the STB 114(A).

As further shown in FIGS. 1 and 2, the television 114(B) may be coupled to the STB 114(2A). For at least one implementation, the television 114(B) may be utilized, by an implementation of the present disclosure, to communicate information regarding the last known location for the remote 200, which may correspond to the current location of the remote 200, to a user. The last known remote location may correspond to a current location of the remote 200 when the remote 200 is within UWB communications range of the STB 114(2A) at a given time that locating of the remote 200 is requested by the user. It is to be appreciated that the remote 200 may not be within UWB communications range of the STB 114(A) when the remote 200 lacks electrical power, or is at a location that is greater than a maximum remote signaling range which, for at least one implementation, is fifty (50) meters from the STB 114(A).

### Remote Tracking and Location Identification System (RTLIS) 300

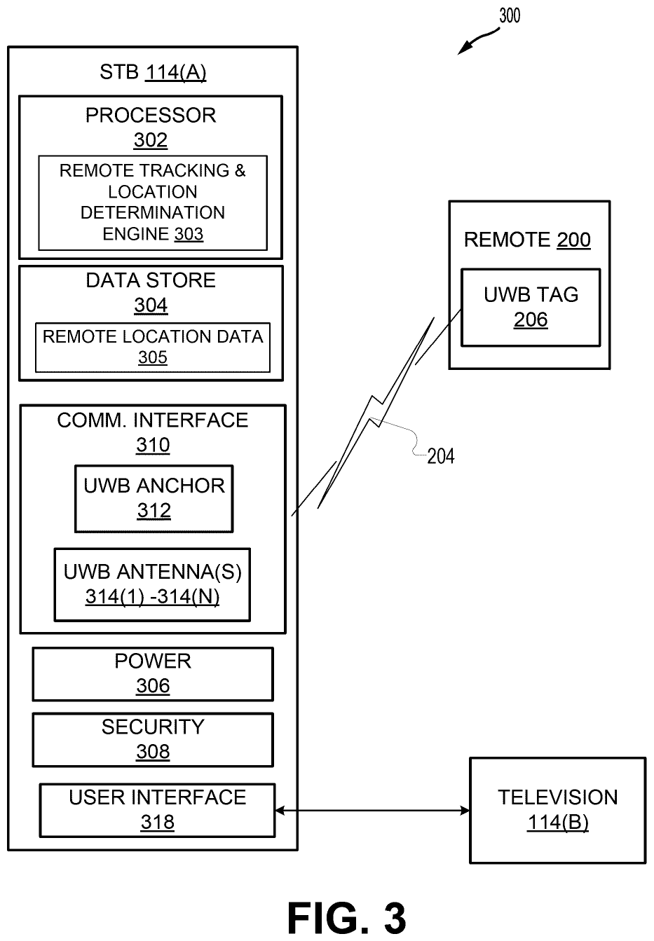

As shown in FIG. 3 and for at least one implementation of the present disclosure, a remote tracking and location identification system (RTLIS) 300 may include the STB 114(A) that is wirelessly coupled by the RRS 204 with the remote 200 and is also coupled to the television 114(B).

For at least one implementation, the remote 200 may be configured to include common remote components, such as a processor, data store, power, user interface, communications interface, and the like. Any known and/or later arising remote components may be utilized in an implementation of the remote 200 for the present disclosure.

In addition to common remote components, the remote 200 is further configured to include a UWB tag (UWBT) 206. The UWBT 206 may be provided as an ultra-wideband physical tag (UWBPT) and/or as an ultra-wideband virtual tag (UWBVT). Herein, UWBPTs and UWBVTs are individually and collectively referred to as a UWBT. For at least one implementation, the UWBT 206 is configured to generate the RRS 204.

As further shown in FIG. 3, the STB 114(A) may be configured to include any known and/or later arising STB components, with a non-limiting example of such components including those provided by a DISH NETWORK HOPPER. For at least one implementation, the STB 114(A) includes an STB processor (STBP) 302 configured to execute first computer instructions which, when executed, instantiate a first remote tracking and location determination engine (1RTLDE) 303. The 1RTLDE 303 configures the STB 114(A) to perform remote tracking operations (RTOs) and remote location identification operations (RLIOs).

The STB 114(A) may be configured to include an STB ultra-wideband anchor (STB-UWBA) 312. The STB-UWBA 312 includes at least one UWB antenna (UWBA) 314 and may include multiple UWBAs 314(1)-(N). The UWBAs 314 may include at least one UWB receiving element (UWBRE) 316 which facilitates determination of a location of the remote 200 based upon when the RRS 204 is received by a given UWBRE 316. The size, shape, configuration, number, and the like of the UWBRE(s) 316 may be selected by a PHOSITA, so as to facilitate determination, by the STBP 302, of a given location of the remote 200, which may be a point in space and/or an area (e.g., within a one foot (1′) circular radius), within a given location accuracy (e.g., plus/minus six inches (6″), and at a given time. It is to be appreciated that the given location and/or given location accuracy may be pre-determined, real-time determined, and/or vary based upon the configuration, number, timing accuracy, and signal processing capabilities of the STBP 302 and of the UWBA(s) 314 utilized by the STB-UWBA 312. For at least one implementation, the UWBA(s) 314 may be configured as a phased array antenna, where an array operates as a distinct UWBRE 316 capable of separately receiving the RRS 204 by numerous arrays with distances between the UWBREs in the array and the orientation of the UWBREs facilitating remote location determinations. For another implementation, the UWBA(s) 314 may be multiple individual UWBREs. Other UWBRE configurations may be used for other implementations.

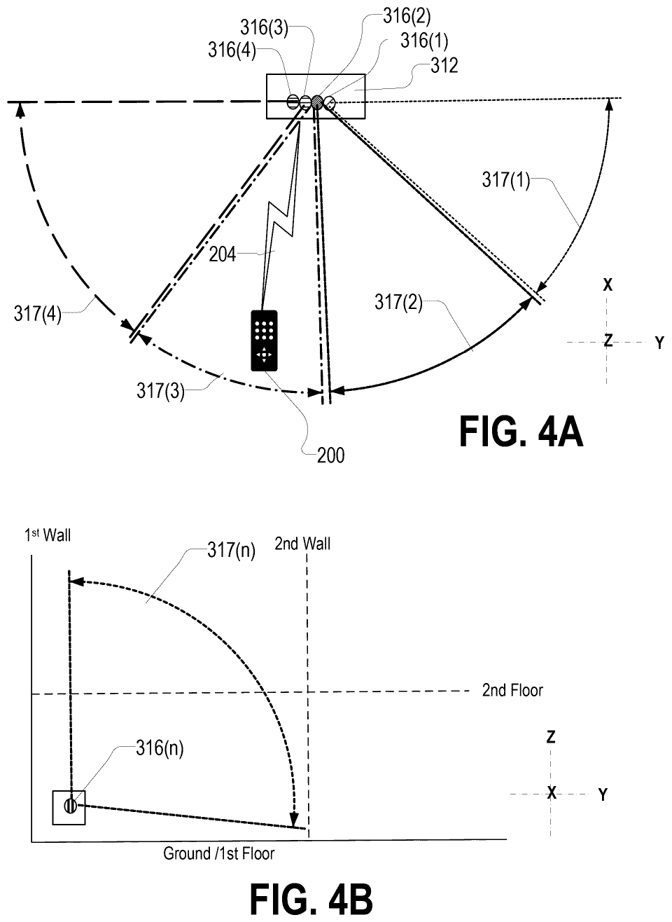

As shown in FIGS. 4A and 4B and for at least one implementation and as shown for purposes of illustration and explanation and not by limitation, the UWBA(s) 314 may include multiple UWBREs 316 including a first UWBRE (1UWBRE) 316(1), a second UWBRE (2UWBRE) 316(2), a third UWBRE (3UWBRE) 316(3), and a fourth UWBRE (4UWBRE) 316(4). Any number of UWBA(s) 314 and/or UWBRE 316 may be utilized in a given implementation of the present disclosure. It is to be appreciated, by a PHOSITA using known Global Positioning System (GPS), LORAN and similar radio frequency based positioning concepts, that at least four UWBREs 316 may be utilized to provide a determine location within a determined location accuracy in a three-dimensional space. For a two-dimensional space, at least three UWBREs 316 may be utilized. For a given one-dimensional space, at least two UWBREs 316 may be utilized.

For at least one implementation, one or more of the UWBREs 316 may be configured to detect the RRS 204 when the remote 200 is located within a field of view 317 of the given UWBRE. For a non-limiting example, the 1UWBRE 316(1) may have a first field-of-view 317(1), the 2UWBRE 316(2) may have a second field-of-view 317(2), the 3UWBRE 316(3) may have a third field-of-view 317(3) and the fourth 4UWBRE 316(4) may have a fourth field of view 317(4). The respective field-of-views 317 may be non-overlapping and/or overlapping, with non-overlapping field-of-views being shown in FIG. 4A for purposes of illustration and not by limitation. The respective field-of-views 317 may extend with respect to one or more dimensions/planes in an X-Y-Z coordinate system, with an nth field-of-view 317(n), as shown in FIG. 4B, including a field-of-view that extends vertically as well as horizontally. Known ranging principles may be used to determine the position of the remote 200 at a given time and at a given location and a given location accuracy.

Using ranging data provided by the multiple UWBA(s) 314 and the multiple UWBREs 316, the 1RTLDE 303 may perform RTOs that include determining, at a given time, the distance of the remote 200 from the STB 114(A) (and/or from the television 114(B), as further described below). For at least one implementation, the 1RTLDE 303 may be configured to facilitate determination of a distance of the remote 200 from the STB 114(A) at a given time based when each of the multiple UWBA(s) 314 and/or UWBRE(s) 316 receive a given RRS 204 transmitted by the UWBT 206. For at least one implementation, one or more of the UWBREs 316 may receive the RRS 204 at a given received signal strength (RSS). For example, the 1UWBRE 316(1) may receive the RRS 204 a first received signal strength (1RSS), the 2UWBRE 316(2) may receive the RRS 204 at a second RSS (2RSS), the 3UWBR 316(3) may receive the RRS 204 at a third RSS (3RSS), and the 4UWBR 316(4) may receive the RRS 204 at a fourth RSS (4RSS).

For at least one implementation, the RTOs may include determining a distance of the remote 200 from the STB 114(A) based on the one or more RSSs for a given RRS 204.

For at least one implementation, the UWBT 206 and the STB-UWBA 312 are configured to utilize one or more frequencies exceeding five-hundred Megahertz (500 MHz). Other frequencies may be utilized in other implementations of the present disclosure.

For at least one implementation, a UWBT 206 may be configured to transmit data over distances of one to fifty meters (1-50 m). For at least one implementation, a UWBT 206 may be configured to transmit data up to a distance of two-hundred meters (200 m). It is to be appreciated that a UWBT 206 may be configured to consume varying levels of power depending on a then arising distance of the remote 200 from the STB 114(A).

For at least one implementation, a UWBT 206 may periodically generate the RRS 204 that includes therein a transmission time. The RRS 204 may be respectively received by the UWBA(s) 314 and/or UWBRE(s) 316 for a given STB-UWBA 312, at uniquely given reception times and/or at uniquely given reception orientations.

Based on differences between the transmission and reception times and the reception orientations, the 1RTLDE 303 may determine a distance and an orientation of the UWBT 206 (and thereby the remote 200) from the given STB-UWBA 312 (and thereby the STB 114(A)) at the given transmit time.

As further shown in FIG. 3 and for at least one implementation, the STB 114(A) includes an STBP 302 that is configured to execute computer instructions including first computer instructions (1CIs) for instantiating a first remote tracking and location determination engine (1RTLDE) 303. The STBP 302 is coupled, by an STB bus (not shown), to an STB data store (STBDS) 304 which, among other data stored, is configured to store remote location data (RLD) 305, a power module 306, a security module 308, a user interface 318 and the STB communications interface (STBCOM) 310. For at least one implementation and amongst other communications components commonly provided with a remote, such as infra-red transmitters and/receivers, BLUETOOTH™ transmitters and receivers and the like, the STBCOM 310 includes the STB-UWBA 312 which further includes the two or more UWBA(s) 314.

Other applications, engines, and modules such as content processing applications, web browser applications, and the like may also be executed by the STBP 302. Other data may be stored by the STBDS 304.

As further shown in FIG. 3, the RTLIS 300 may include the television 114(B) or other audio and/or video presentation device. The television 114(B) may include any device capable of presenting one or more of first remote distance data (1RDD), first remote orientation data (1ROD) and first graphical icon data (1GID) (herein, individually and collectively, the first remote location data (1RLD)). For at least one implementation, the 1GID may be generated, by the 1RTLDE and as based on the 1RDD and the 1ROD, as a vector or other indicator. The 1RLD, as generated by the 1RTLDE 303 and received from the STB 114(A), is converted by the TV 114(B) into first remote location information (1RLI) for presentation to a user. For at least one implementation, the television 114(B) may be provided as a display on a smartphone device, a tablet device, or otherwise. The 1RLI presented to a user may take any form and may include any level of detail to be provided, as facilitated by a given implementation of the present disclosure.

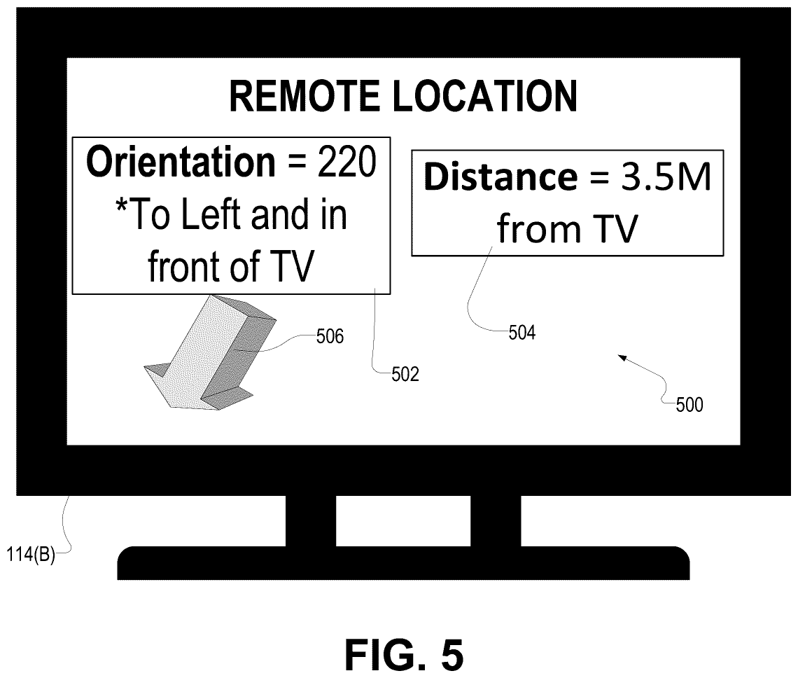

As shown in FIG. 5 and for at least one implementation of the present disclosure, the 1RLI may include RLI 500 presented on a display area of the television (TV) 114(B). For example, the 1RLI 500 may include a first text field 502 providing in a textual form first remote orientation information (1ROI) for the remote 200 relative to the TV 114(B), a second text field 504 providing first remote distance information (1RDI) for the remote 200 from the TV 114(B), and a graphics field 506 providing a first graphical icon (1GI) identifying where the remote 200 was last determined to be relative the TV 114(B). For at least one implementation, the relative size of the 1GI may vary based on the distance of the remote 200 from the TV 114(B). For at least one implementation, one or more of the data fields may be integrated into a single graphical and/or textual field.

It is to be appreciated that when the STB 114(A) and the TV 114(B) (on which the RLI 400 is being presented) are substantially adjacent, the 1OI, 1DI and/or 1GI generated may be substantially the same, as determined relative to the STB 114(A) versus relative to the TV 114(B). As used in this context, “adjacent” means that the STB 114(A) and the TV 114(B) are within thirty centimeters (30 cm) of each other and are substantially linear with respect each other, for example, being placed on or in a given article 116, such as an entertainment center or the like. When the STB 114(A) and the TV 114(B) are not adjacent (as used in this context), the orientation and distance of the remote 200 from the TV 114(B), vs the orientation and distance of the remote 200 from the STB 114(A) may differ substantially-that is by more than ten percent (10%). Accordingly, for at least one implementation, the STB 114(A) may be configured, during an initial configuration phase, to specify the relative distance and orientation of the STB 114(A) relative to the TV 114(B) and using such initial configuration information, generate the 1OI, 1DI and 1GI. For example, the STB 114(A) may be located parallel to, above, below, in another room and at any distance from the TV 114(B). The 1RTLDE 303 may be configured to take such relative positioning data into account when determining an adjusted distance and/or an adjusted orientation of the remote 200 to the TV 114(B) and to present the as adjusted distance and orientation data in the RLI 500.

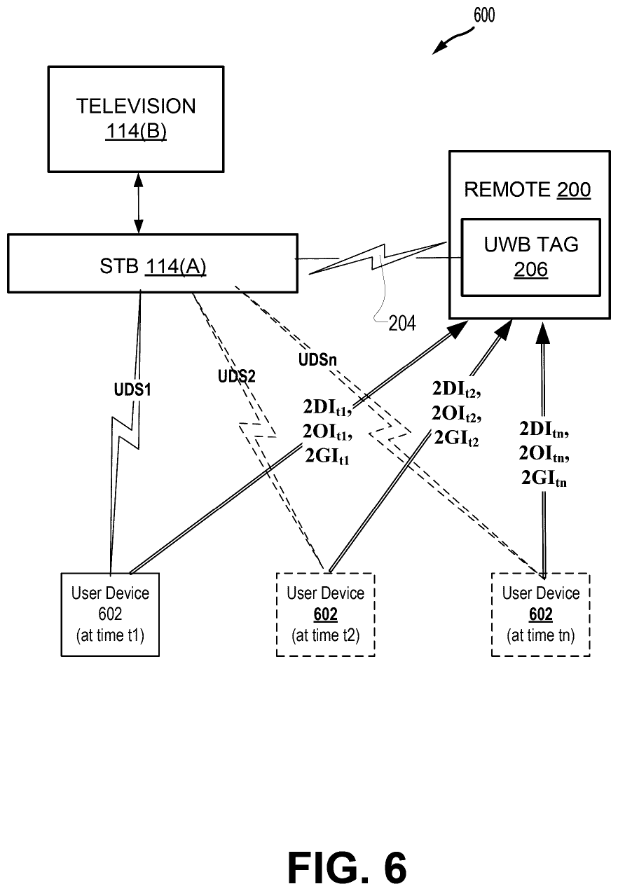

As shown in FIG. 6 and for at least one implementation of the present disclosure, a second implementation of an RTLIS (herein, a “2RTLIS”) may be configured to couple the STB 114(A) with a non-adjacent user device (UD) 602 (as defined above). The user device 602 may include a processor (not shown) configured to execute second computers instructions which instantiate a second RTLDE (2RTLDE) (not shown) which configures the user device 602 to perform remote locating operations. For at least one implementation, the user device to remote location operations may include the 2RTLDE generating second remote location data (2RLD), which may include second remote distance data (2RDD), second remote orientation data (2ROD), and/or second graphical icon data (2GID). The 2RDD, 2ROD and 2GID provide data that the user device 602 may convert and present, to a user audibly and/or visually, e.g., using a user device display (not shown), as second remote distance information (2RDI), second remote orientation information (2ROI) and/or at least one second graphical icon (2GI). The “second instances” of such data and information being based on a current location of the user device 602 relative to the current location of the remote 200. The second instances of such data and information thereby differ from the implementation of FIG. 5, which as discussed above is based on the known (typically fixed) location of the STB 114(A) and/or the television 114(B). Using the 2RDI, 2ROI and/or 2GI, the user of the user device 602 may be directed from their current location (as represented by the location of the user device 602) to the current location of the remote 200. As discussed above, the current location of the remote 200 may be the last known location of the remote 200.

For at least one implementation, the 2RTLDE may be configured to determine the 2RLD based on a determination of the location of the user device 602 at a current time relative to the STB 114(A)—the distance of the remote 200 relative to the STB 114(A) being determined by the 1RTLDE 303, as discussed above—and as further based on a determination of the user device 602, at a given time, relative to the remote 200. For at least one implementation, the user device 602 may function as an STB-UWBA 312 that further facilitates identification of the remote 200 using the principles discussed above for the STB 114(A). It is to be appreciated that such functionality may be utilized when the remote 200 is currently at a location that is beyond the RRS 204 range (with respect to the STB 114(A)) and/or has been relocated to another position when in a no power or reduced power condition such that the remote 200 is no longer (effectively) paired to the STB 114(A).

For at least one implementation, the user device 602 may be coupled to the STB 114(A) by a duplex user device signal (UDS). As shown in FIG. 6, when the user device 602 moves about an environ 100, the orientation and distance of the user device 602 from the STB 114(A) may vary. Such differences in orientation and distance may be determined, based on the UDS and using known ranging principles, by the 1RTLDE 303 and/or the 2RTLDE. The UDS may be received (and transmitted) by the STB 114(A) using the STBUWBA312, UWBA(s) 314 or other antennas.

For at least one implementation, the user device 602 may be configured with a UWB component (not shown) that functions as a user device UWB tag (herein, a “UD-UWBT”) with respect to the STB 114(A)). At a first time, t1, a first UDS signal (UDSₜ₁) may be communicated by and between the user device 602 and the STB 114(A). At a second time, t2, a second UDS signal (UDSₜ₂) may be communicated. At an nth time, tn, an nth UDS (UDSₜₙ) may be communicated. A given UDS may include data which identifies and/or can be processed by the 1RTLDE 303 (as instantiated by the STBP 302) to identify a current location for the user device 602 relative to the STB 114(A) (herein, the “user device location data” (UDLD)). For at least one implementation, the UDLD may include user device distance data (UDDD), which identifies a distance of the user device 602 from the STB 114(A), and user device orientation data (UDOD), which identifies an orientation of the user device 602 relative to the STB 114(A). Based on the UDLD, and the remote location data (which may be generated by the RTLDE—as discussed above) the 1RTLDE 303 may generate and provide 2RLI to the user, with such data being based on the current location of the user device 602 at a given time (t1-tn).

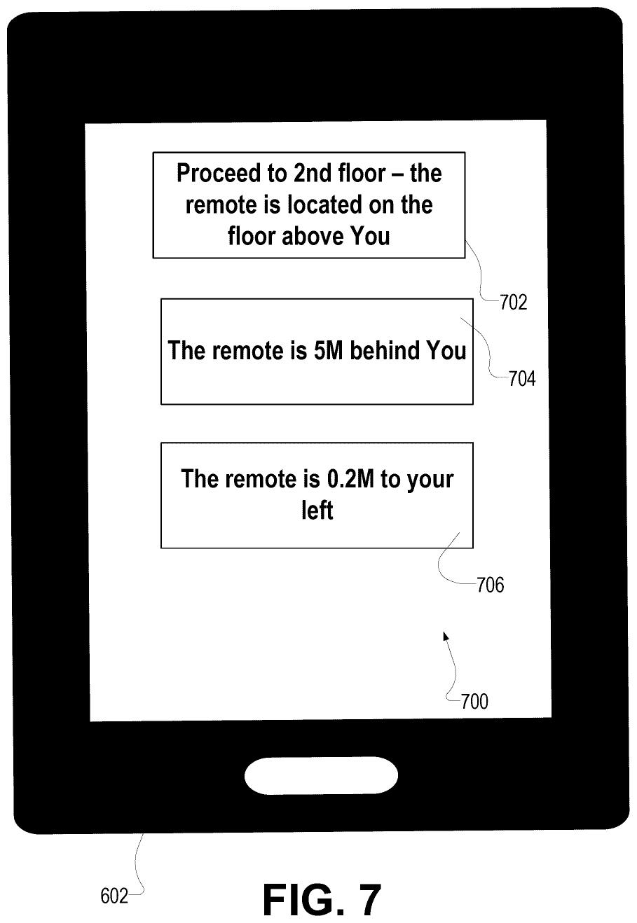

As shown in FIG. 7 and for at least one implementation of the present disclosure wherein a user device 602 is utilized to convey remote location information to a user, the user device 602 may include a display 700. The 2RTLDE may be configured to generate instructions which may be presented to a user audibly, visually, or otherwise. The instructions may instruct a user how to proceed from a current location to the current remote location. For example, at time t1, a first instruction 702 may instruct the user to proceed up a floor (e.g., to the 2^{nd} floor) and/or inform the user that the remote is located on a given floor above the user's current location. At time t2, e.g., when the user has arrived on the 2^{nd} floor, a second instruction 704 may be presented on the display 700 that informs the user where on the 2^{nd} floor the remote is located, e.g., informing the user that the remote is located a given distance (e.g., five meters (5 m)) behind, in front of, to the side of, etc. the user. It is to be appreciated that the orientation of the user device 602 (and thereby the user) may be further determined, when available, using gyroscopes and the like that are commonly provided in smart phones and other forms of user devices. Further, at time tn, e.g., when the user device location is proximate to the current remote location (herein, “proximate” meaning within one meter (1 m) thereof) an nth instruction 706 may be presented on the display 700 that informs the user that they are adjacent to the remote 200 (in this context, “adjacent” meaning within one meter (1 m) or less between the remote 200 and the user device 602).

For at least one implementation of the present disclosure, the 1RTLDE 303 may be configured to perform one or more mapping operations that utilize one or more floor plans, building models, and the like (herein, “floor plan data” (FPD)) to generate RLI that depicts the current location of the remote 200 in relation to the floorplan, or the like of the environ. For example, the 1RTLDE 303 may generate RLI that identifies the current location of the remote 200 as being, e.g., “in the living room,” “in the kitchen,” or the like. For an implementation, the RLI may include one or more graphical icons that identify the location of the remote 200 using the FPD. For at least one implementation, the FPD may be provided by the user, obtained from a third party source, such as a county building department, or an appraisal report, from a housing description service, such as ZILLOW, or otherwise.

For at least one implementation of the present disclosure, the 1RTLDE 303 may be configured to utilize one or more photographs, videos or other images (herein, “video data” (VD)) that depict one or more areas of the environs 100 to generate RLI that depicts the current location of the remote 200 relative to one or more articles 112 depicted in the VD. For example, the RLI may include information that informs the user that the remote 200 is located “on the sofa.” To provide such RLI, the 1RTLDE 303 may be configured to perform one or environ mapping operations whereby locations of the remote 200 relative to articles 112 in a given room can be determined. The environ mapping operations may include having the user identify locations, and articles at such locations, within the environ during an initial set-up of the STB 114(A). For example, the user may be instructed to “sit at the primary viewing location” (e.g., the sofa 112(2B)) and depress a remote button. The 1RTLDE 303 may be configured to record the location as coinciding with “the sofa” and the RLD received at that time. For another implementation, a camera on the STB 114(A), or otherwise (e.g., on the user device 602) may be utilized to capture visible data depicting the “sofa” location. Using such visible data, the 1RTLDE 303 may be configured to generate graphical icon data (GID) that can be used to generate one or more graphical icons that depict the remote as being currently located on a given article, such as the sofa 112(2B).

For at least one implementation, the 1RTLDE 303 may be configured to utilize article identification technologies, such as those used to identify articles on websites, to identify, from a photo, one or more articles 112 in a given environ. The 1RTLDE 303 may be further configured to utilize known and/or later arising environ organizing technologies to determine relative distances of articles 112 within a given environ. Using such technologies, the 1RTLDE 303 may be configured to determine a current location of a remote 200, within a given environ 100, and relative to one or more articles 112 therein, as depicted in one or more images or video captured, at a given current time, by the user device 602. For example, a user may be instructed, based on the 2DI and 2OI previously generated, to capture VD of a given confine area 110 corresponding thereto. The VD may have any given form including but not limited to a portrait, landscape, panoramic, time-lapse, series of images, sequence of images, video or otherwise. Using the VD, the 2RTLDE may be configured to generate one or more 2GIs that identify, with specificity, the current location of the remote 200 relative to a given confine 106, confine area 110, and/or one or more articles 112 within the given confine 106 and/or confine area 110.

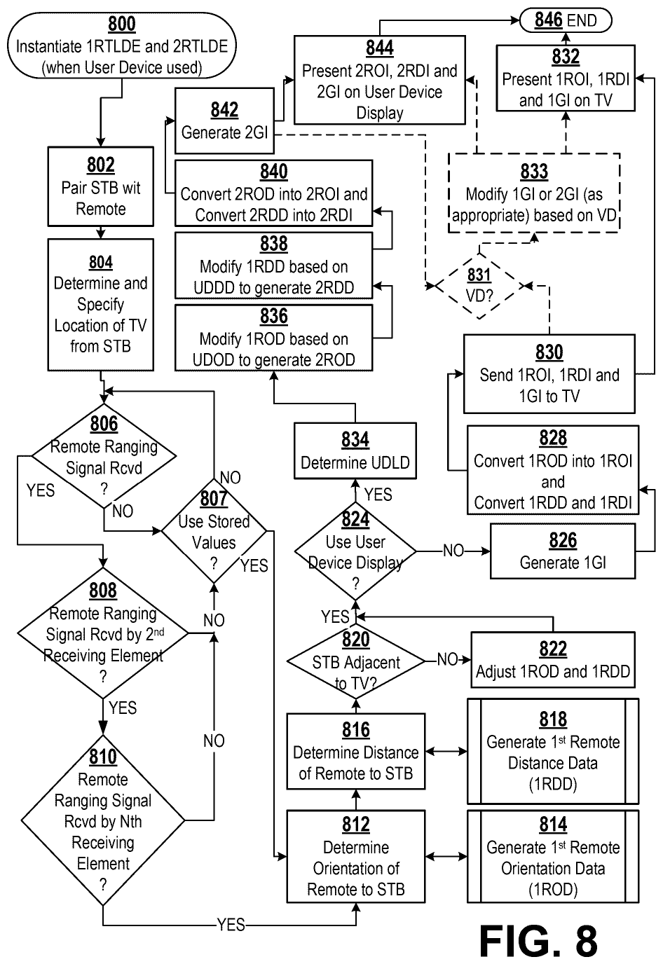

As shown in FIG. 8 and for at least one implementation, a process for remote tracking and location identification may include, as per Operation 800, instantiating the 1RTLDE. As discussed above, the 1RTLDE is instantiated by the STBP 302. When a user device 602 is to be utilized to present the remote location information, the process may also include the user device processor instantiating the 2RTLDE. For at least one implementation, Operation 800 may be initiated by a user depressing a “find remote” button or the like on the STB 114(A).

As per Operation 802 and for at least one implementation, the process may include pairing the STB 114(A) with the remote 200. Any known or later arising techniques for pairing the STB 114(A) with the remote 200 may be utilized.

As per Operation 804, the process may include determining and specifying the location of the TV 114(B) relative to the STB 114(A).

As per Operation 806 and for at least one implementation, the process may include determining if a remote ranging signal has been recently received by a receiving element 316 of the UWBA(s) 314. As used herein “recently” means within the preceding pre-determined period, which for at least one implementation is twenty-four (24) hours. If “YES,” the process may proceed to Operation 808. If “NO,” the process may proceed to Operation 807.

As per Operation 807 and for at least one implementation, the process may include determining whether one or more stored instances of remote location data (RLD) is to be utilized. The stored instance(s) of RLD indicate a last known location of the remote 200 when remote ranging signals are not being received, at a given time. The process may proceed to Operation 812 and may include using one or more instance of stored and/or received remote ranging signals, stored instances of RDD and/or ROD, and the like.

As per Operation 808 and for at least one implementation, the process may include determining if a second remote ranging signal has been received by a second UWBRE 316(2) of the UWBA(s) 314. If “YES,” the process may proceed to Operation 810. If “NO,” the process may proceed to Operation 807.

As per Operation 810 and for at least one implementation, the process may include determining if a remote ranging signal has been received by an nth receiving element for the UWBA(s) 314. As discussed above, for at least one implementation, the remote ranging signal is received by at least four (4) receiving elements 316 of the UWBA(s) 314. For other implementations, three (3) or more receiving elements 316 may be utilized. It is to be appreciated that as the number of receiving elements 316 receiving a given remote ranging signal increases, the accuracy of distance and orientation determinations of the remote 200 from the STB 114(A) and/or TV 114(B) increases. If “YES,” the process may proceed to Operation 812. If “NO,” the process may proceed to Operation 807.

As per Operations 812 and 814 and for at least one implementation, the process may include determining the current orientation of the remote 200 to the STB 114(A). The determining may utilize one or more remote ranging signals received by the one or more UWB antenna receiving elements 316 and/or one or more instances of stored data. A result of the determining may include the generation of the first remote orientation data (1ROD).

As per Operation 816 and 818 and for at least one implementation, the process may include determining the current distance of the remote 200 to the STB 114(A). The determining may utilize one or more remote ranging signals received by the one or more UWB antenna receiving elements 316 and/or one or more instances of RLD. A result of the determining may include the generation of the first remote distance data (1RDD).

As per Operation 820 and for at least one implementation, the process may include determining if the STB 114(A) is adjacent to the TV 114(B). As discussed above, “adjacent” here means that the STB 114(A) and TV 114(B) are within thirty centimeters (30 cm) of each other. If “YES,” the process may proceed to Operation 824. If “NO,” the process may proceed to Operation 822.

As per Operation 822 and for at least one implementation, the process may include adjusting one or more, if not both, of the 1ROD and the 1RDD when the STB 114(A) and the TV 114(B) are not “adjacent.” The process may then proceed to Operation 824.

As per Operation 824 and for at least one implementation, the process may include determining whether the user device display is to be utilized to locate the remote 200. If “YES,” the process may proceed to Operation 834. If “NO,” the process may proceed to Operation 826.

As per Operation 826 and for at least one implementation, the process may include generating the 1GI. As discussed above, the 1GI may be generated based on the 1ROD and/or 1RDD respectively generated per Operations 814 and 818.

As per Operation 828 and for at least one implementation, the process may include converting the 1ROD into 1ROI and the 1RDD into 1RDI.

As per Operation 830 and for at least one implementation, the process may include sending the 1ROI, 1RDI and 1GI to the TV 114(B).

As per Operation 831 and for at least one implementation wherein video data (VD) of a confine 106 and/or the environ 100 is to be utilized to generate the RLI, the process may include determining if the VD exists. The determining may be made based on the ROI and RDI generated, per Operation 830 or Operation 840. If “YES,” the process may proceed to Operation 833. If “NO,” the process may return to Operation 830 or 842.

As per Operation 832 and for at least one implementation, the process may include presenting the 1ROI, 1RDI and the 1GI on the TV 114(B). The process may then proceed to Operation 846 and, assuming the remote 200 has been located, ends. When the remote 200 has not been located, the process may resume at Operation 824 and the user device 602 may be used to locate the remote 200.

As per Operation 834 and for at least one implementation, the process may include determining the user device location data (UDLD). One implementation for determining of the UDLD is discussed above but any known or later arising implementations or technologies for determining the UDLD and providing such data to one or more of the 1RTLDE or the 2RTLDE may be utilized in an implementation of the present disclosure.

As per Operation 836 and for at least one implementation, the process may include modifying the 1ROD based on the user device orientation data (UDOD) to generate the 2ROD.

As per Operation 838 and for at least one implementation, the process may include modifying the 1RDD based on the user device distance data (UDDD) to generate the 2RDD.

As per Operation 840 and for at least one implementation, the process may include converting the 2ROD into 2ROI and converting the 2RDD into 2RDI.

As per Operation 842 and for at least one implementation, the process may include generating, based on the 2RDD and the 2RDI, at least one second graphical icon (2GI). As shown, the process may then proceed to Operations 831 and 833 when VD data is to be utilized, or to Operation 844, when VD data is not to be utilized.

As per Operation 844 and for at least one implementation, the process may include presenting the 2ROI, 2RD, and 2GI on the user device display.

As per Operation 846 and for at least one implementation, the process ends.

It is to be appreciated that the operations shown in FIG. 8 may be performed in a different order, sequence, or otherwise. Provided that at least one setting of at least one device in a hotel room is configured in accordance with at least one user preference and the configuring thereof occurs prior to arrival of a given user to the hotel room and in view of a determined location of the user relative to the hotel room.

Although various implementations have been described above with a degree of particularity, or with reference to one or more individual implementations, those skilled in the art could make alterations to the disclosed implementations without departing from the spirit or scope of the present disclosure. The use of the terms “approximately” or “substantially” means that a value of an element has a parameter that is expected to be close to a stated value or position. As is well known in the art, there may be minor variations that prevent the values from being as stated. Accordingly, anticipated variances, such as 10% differences, are reasonable variances that a person having ordinary skill in the art would expect and know are acceptable relative to a stated or ideal goal for one or more implementations of the present disclosure. It is also to be appreciated that the terms “top” and “bottom,” “left” and “right,” “up” or “down,” “first,” “second,” “next,” “last,” “before,” “after,” and other similar terms are used for description and ease of reference purposes and are not intended to be limiting to any orientation or configuration of any elements or sequences of operations for the various implementations of the present disclosure. Further, the terms “coupled,” “connected” or otherwise are not intended to limit such interactions and communication of signals between two or more devices, systems, components or otherwise to direct interactions; indirect couplings and connections may also occur. Further, the terms “and” and “or” are not intended to be used in a limiting or expansive nature and cover any possible range of combinations of elements and operations of an implementation of the present disclosure. Other implementations are therefore contemplated. It is intended that matter contained in the above description and shown in the accompanying drawings be interpreted as illustrative of implementations and not limiting. Changes in detail or structure may be made without departing from the basic elements of the present disclosure as described in the following claims.

1. A system comprising:
a remote control device comprising:
an ultra-wideband (UWB) tag (UWBT) generating a given remote ranging signal (GRRS); and
a set top box (STB), coupled to the remote control device, comprising:
an STB processor (STBP);
an STB UWB anchor (STB-UWBA), coupled to the STBP, including:
a first UWB receiving element (1UWBRE); and
a second UWB receiving element (2UWBRE); and
a non-transitory STB data store (STBDS), coupled to the STBP, non-transitorily storing:
first computer instructions (1CIs); and
wherein the 1CIs, when executed by the STBP, instantiate a first remote tracking and location determination engine (1RTLDE) which configures the STB to perform remote tracking operation (RTOs) comprising:
first receiving the GRRS by the 1UWBRE;
second receiving the GRRS by the 2UWBRE; and
determining, based on the first receiving and the second receiving, a current distance of the remote control device from the STB at a given current time;
wherein the 1UWBRE has a first field-of-view (1FOV);
wherein the 2WUBRE has a second field-of-view (2FOV); and
wherein the current distance is further determined based on differences between the 1FOV and the 2FOV; and
wherein the 1FOV overlaps with the 2FOV.

2. (canceled)

3. (canceled)

4. (canceled)

5. The system of claim 1,
wherein the STB-UWBA further comprises:
a third UWB receiving element (3UWBRE) having a third field-of-view (3FOV); and
wherein the RTOs further comprise:
third receiving the GRRS by the 3UWBRE; and
second determining, based on the 1FOV, the 2FOV and the 3FOV, a current orientation, in a two-dimensional space, of the remote control device relative to the STB.

6. The system of claim 5,
wherein the STB is positioned at a fixed location in an environ; and
wherein the current distance with the current orientation identify a current location of the remote control device relative to the fixed location of the STB in the environ.

7. The system of claim 5,
wherein the STB-UWBA further comprises:
a fourth UWB receiving element (4UWBRE) having a fourth field-of-view (4FOV); and
wherein the RTOs further comprise:
fourth receiving the GRRS by the 4UWBRE; and
third determining, based on the 1FOV, the 2FOV, the 3FOV and the 4FOV, a current orientation, in a three-dimensional space, of the remote control device relative to the STB.

8. The system of claim 7,
wherein the RTOs further comprise:
determining, at least one of:
for the first receiving, a first received signal strength (1RSS) of the GRRS;
for the second receiving, a second received signal strength (2RSS) of the GRRS;
for the third receiving, a third received signal strength (3RSS) of the GRRS; and for the fourth receiving, a fourth received signal strength (4RSS) of the GRRS; and
wherein the current distance is further determined based on at least one of the 1RSS, the 2RSS, the 3RSS and the 4RSS.

9. The system of claim 8,
wherein the GRRS is transmitted by the UWBT at a given transmission time;
wherein the GRRS identifies the given transmission time;
wherein the GRRS is received by at least one of the 1UWBRE, the 2UWBRE, the 3UWBRE, and the 4UWBRE;
wherein the 1UWBRE receives the GRRS at a first reception time;
wherein the 2UWBRE receives the GRRS at a second reception time;
wherein the 3UWBRE receives the GRRS at a third reception time;
wherein the 4UWBRE receives the GRRS at a fourth reception time;
wherein the first reception time, the second reception time, the third reception time and the fourth reception time occur after the given transmission time; and
wherein the distance of the remote control device from the STB is determined based on differences between the transmission time and one or more of the first reception time, the second reception time, the third reception time and the fourth reception time.

10. The system of claim 9,
wherein the first reception time differs from the second reception time;
wherein at least one of the first reception time and the second reception time differ from the third reception time; and
wherein at least two of the first reception time, the second reception time and the third reception time differ from the fourth reception time.

11. The system of claim 5, further comprising:
a user device (UD) coupled to the STB; and
wherein the RTOs further comprise:
determining, at the given current time:
a second distance of the UD from the STB and
a second orientation of the UD relative to the STB;
adjusting the current distance of the remote control device to the STB based on the second distance to generate a revised distance indicative of a distance of the remote control device to the UD at the given current time; and
adjusting the current orientation of the remote control device to the STB based on the second orientation to generate a revised orientation indicative of an orientation of the remote control device to the UD at the given current time; and
outputting, to the UD, second remote location data (2RLD) indicative of the revised distance and the revised orientation.

12. The system of claim 11,
wherein the UD comprises:
a user device user interface (UDUI);
a user device communications interface (UDCI);
a non-transitory UD data store (UDDS), non-transitorily storing second computer instructions (2CIs); and
a UD processor (UDP), coupled to the UDUI, the UDCI, and the UDDS; and
wherein the 2CIs, when executed by the UDP, instantiate a second remote tracking and location determination engine (2RTLDE) which configures the UD to perform second remote location operations (2RLOs) comprising:
receiving the 2RLD from the STB;
wherein the 2RLD includes second remote distance data (2RDD), second remote orientation data (2ROD), and second graphical icon data (2GID);
converting the 2RLD into second remote distance information (2RDI), second remote orientation information (2ROI), and at least one second graphical icon (2GI); and
presenting, via the UDUI, the 2RDI and the 2ROI to the user.

13. The system of claim 12,
wherein the UDUI presents the at least one 2GI as an arrow indicative of the revised distance and the revised orientation.

14. The system of claim 1, further comprising:
a television (TV) coupled to the STB;
wherein the 1RTLDE performs remote location operations (RLOs) comprising:
determining whether the STB and the TV are adjacent;
when not adjacent, determining a relative distance of the STB to the TV; and
adjusting the current distance of the remote control device from the STB by the relative distance to generate an adjusted distance indicative of a distance of the remote control device to the TV.

15. The system of claim 14, further comprising:
wherein the 1RTLDE further performs remote location operations (RLOs) comprising:
when the STB and TV are not adjacent, determining a relative orientation of the STB to the TV; and
adjusting the current orientation of the remote control device to the STB by the relative orientation to generate an adjusted orientation indicative of an orientation of the remote control device to the TV.

16. The system of claim 15,
wherein the 1RTLDE further configures the STB to perform remote location operations (RLOs) comprising:
generating first remote distance data (1RDD) indicative of at least one of the current distance and the adjusted distance;
generating first remote orientation data (1ROD) indicative of at least one of the current orientation and the adjusted orientation; and
outputting the 1RDD and the 1ROD to the TV for presentation to a user.

17. The system of claim 16,
wherein the RLOs further comprise:
generating first graphical icon data (1GID) based on the 1RDD and 1ROD.

18. The system of claim 17,
wherein the TV converts the 1RDD into first remote distance information (1RDI);
wherein the TV converts the 1ROD into first remote orientation information (1ROI);
wherein the TV converts the 1GID into a first graphical icon (1GI); and
wherein the TV presents the 1RDI, the 1ROI and the 1GI, in a humanly perceptible format, to at least one user.

19. The system of claim 1,
wherein the STB is located at fixed location with an environ at the given current time;
wherein the remote control device is located at a second location within the environ that is at the current distance from the STB;
wherein the 1RTLDE configures the STB to perform mapping operations comprising:
obtaining a floor plan of the environ;
wherein the floor plan identifies a given confine within the environ;
identifying, within the given confine, a first confine area at which the STB is located at the given current time;
determining, based on the current distance whether the remote control device is within the first confine area; and
when the remote control device is determined to be within the first confine area, generating first remote location data indicative thereof; and
when the remote control device is determined to not be within the first confine area,
identifying at least one second given confine, within the environ, that is within the current distance of the remote control device; and
generating second remote location data indicative thereof.

20. The system of claim 19,
wherein the mapping operations further comprise:
identifying an article in the first confine area; and
wherein the first remote location data further identifies the current location of the remote control device relative to the article.

21. A non-transitory computer readable medium storing first computer instructions (1CIs) which, when executed by a set-top box (STB) processor (STBP), instantiate a first remote tracking and location determination engine (1RTLDE) which configures the STB to perform remote tracking operation (RTOs) comprising:
first receiving, by a first ultra-wideband (UWB) receiving element (1UWBRE) of an STB UWB anchor (STB-UWBA), a given remote ranging signal (GRRS) transmitted by an UWB tag provided with a remote control device;
wherein the 1UWBRE has a first field-of-view (1FOV);
second receiving the GRRS by a second UWB receiving element (2UWBRE);
wherein the 2WUBRE has a second field-of-view (2FOV);
wherein the 1FOV overlaps with the 2FOV; and
determining, based on the first receiving and the second receiving and a determined difference between the 1FOV and the 2FOV, a current distance of the remote control device from the STB.

22. The non-transitory computer readable medium of claim 21,
wherein the STB is located at fixed location with an environ at the given current time;
wherein the remote control device is located at a second location within the environ that is at the current distance from the STB;
wherein the 1RTLDE configures the STB to perform mapping operations comprising:
obtaining a floor plan of the environ;
wherein the floor plan identifies a given confine within the environ;
identifying, within the given confine, a first confine area at which the STB is located at the given current time;
determining, based on the current distance whether the remote control device is within the first confine area; and
when the remote control device is determined to be within the first confine area, generating first remote location data indicative thereof; and
when the remote control device is determined to not be within the first confine area,
identifying at least one second given confine, within the environ, that is within the current distance of the remote control device; and
generating second remote location data indicative thereof.

23. A set top box (STB) comprising:
an STB processor (STBP);
an STB ultra-wideband (UWB) anchor (STB-UWBA), coupled to the STBP, including:
a first UWB receiving element (1UWBRE);
wherein the 1UWBRE has a first field-of-view (1FOV);
a second UWB receiving element (2UWBRE);
wherein the 2WUBRE has a second field-of-view (2FOV);
wherein the 1FOV overlaps with the 2FOV; and
a non-transitory STB data store (STBDS), coupled to the STBP, non-transitorily storing first computer instructions (1CIs) which, when executed by the STBP, instantiate a first remote tracking and location determination engine (1RTLDE) that configures the STB to perform remote tracking operation (RTOs) comprising:
first receiving, by the 1UWBRE, a given remote ranging signal (GRRS) generated by an ultra-wideband tag in a remote control device;
second receiving the GRRS by the 2UWBRE; and
determining, based on the first receiving and the second receiving and determined differences between the 1FOV and the 2FOV, a current distance of the remote control device from the STB.
